(19) United States
(12) Patent Application Publication
(10) Pub. No.: US 2008/0082791 A1
(43) Pub. Date: Apr. 3, 2008

(54) Providing temporary storage for contents of configuration registers

(76) Inventors: Srinivas Chennupaty, Portland, OR (US); Avinash Sodani, Portland, OR (US); Brent Boswell, Aloha, OR (US); Mark Seconi, Beaverton, OR (US)

Correspondence Address: TROP PRUNER & HU, PC, 1616 S. VOSS ROAD, SUITE 750, HOUSTON, TX, 77057-2631, US

(21) Appl. No.: 11/540,337

(22) Filed: Sep. 29, 2006

(51) Int. Cl. G06F 9/30

(52) U.S. Cl. 712/217

(57) ABSTRACT

In one embodiment, the present invention includes a method for assigning a first identifier to a first instruction that is to write control information into a configuration register, assigning the first identifier to a second instruction that is to read the control information written by the first instruction, and storing the second instruction in a first structure of a processor with the first identifier. Other embodiments are described and claimed.

### BACKGROUND

In today's processors, there are many different operations that are performed on data, including operations on various data types, such as integer, floating point, as well as scalar and vector operation types. To perform operations as desired, an execution unit of the processor may be configured to operate according to particular settings such as set forth in one or more configuration registers. Oftentimes, instructions will cause these configuration registers to be updated to perform operations according to different modes. However, in doing so a performance penalty may be incurred, as there may be a latency associated with changing the state of such registers. For example, to effect a change to a configuration register, the current state first may be stored in a storage location, new state loaded, and finally an operation performed using the new state of the configuration register. Then, after retirement of the instruction associated with this operation, the previous state may be reloaded into the configuration register. All of these actions may require many processor cycles, and can thus hinder effective performance.

### BRIEF DESCRIPTION OF THE DRAWINGS

FIG. 1 is a block diagram of a portion of a processor in accordance with one embodiment of the present invention.

FIG. 2 is a flow diagram of a method of allocating instructions in accordance with an embodiment of the present invention.

FIG. 3 is a flow diagram of a dispatch method in accordance with one embodiment of the present invention.

FIG. 4 is a flow diagram of a retirement method in accordance with an embodiment of the present invention.

FIG. 5 is a block diagram of a system in accordance with an embodiment of the present invention.

### DETAILED DESCRIPTION

In various embodiments, information that is typically present in configuration registers and status registers (or combinations thereof) such as control and configuration information (note the terms control and configuration are used interchangeably herein), exception status indicators, masks for such status indicators and so forth, may be stored in a register file. In so doing, the expense of updating the state of such configuration registers may be reduced. That is, the register file may include storage for multiple replicated copies of data from various instructions that write to at least a portion of the information present in status and configuration registers. To maintain ordering of this data and accurate use by different instructions, dependencies between an instruction that writes to such a control register and instructions dependent thereon may be tracked. Furthermore, the sequence of operations performed using this data may also be tracked. That is, because the dependencies are tracked, dependent operations may be held until the writing instruction is executed so that the control information provided by the writing instruction is present in the indicated entry of the register file. After execution of the writing instruction, the dependent instructions may be scheduled for execution, as the proper values in the control register to be used by these instructions are guaranteed to be present in the indicated entry of the register file. In other words, the execution of the writer instruction that loads the control information into the indicated entry of the register file can be used as a trigger to allow execution of dependent instructions.

Various control and status registers may take advantage of embodiments of the present invention to enable replicated copies of the contents of these registers to be stored so that multiple writer instructions and dependent instructions (e.g., reader instructions) can be performed in a processor without the need for frequent updates to the actual contents of these registers, enabling low latency between issuance of a writer instruction and one or more instructions dependent thereon. While the scope of the present invention is not limited in this regard, various control and status registers, including a floating point control word (FCW) that is used to provide control and mask information for use in connection with floating point operations may have replicated copies of its state available in a register file. Similarly, a multimedia control and status register (e.g., the MXCSR as present in an x86 processor) that is used in performing operations on single instruction multiple data (SIMD) may also have multiple replicated copies of its information available in a register file.

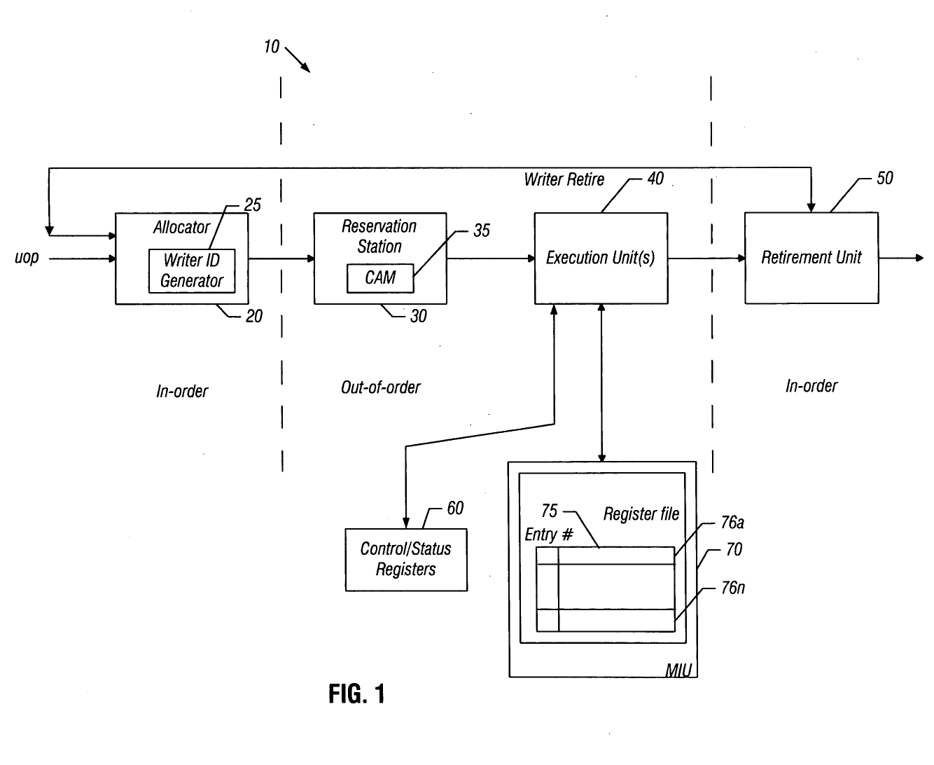

While embodiments of the present invention may be implemented in many different processor types, referring now to FIG. 1, shown is a block diagram of a portion of a processor in accordance with one embodiment of the present invention. As shown in FIG. 1, processor 10 includes a front-end in-order portion, an out-of-order portion, and a back-end in-order portion. With such an architecture, instructions may be efficiently handled, as when needed resources are available, instructions may be performed out of order to increase the number of operations performed per processor cycle. At the back-end stage, such instructions performed out of order may be reordered back into program order.

As shown in FIG. 1 incoming instructions, which may be decoded micro-operations (μops), may be received by an allocator 20. Allocator 20 may track the state of resources that may be needed by instructions. For example, allocator 20 may track the availability of storage in load and store buffers, or other structures. If one or more needed resources for an instruction is not available, allocator 20 may hold the instruction until availability exists.

As shown in FIG. 1, allocator 20 includes a writer identifier (ID) generator 25. Writer ID generator 25 may be used to allocate an identifier to incoming μops that write information into configuration registers (a “writer μop”). For purposes of illustration herein, one representative configuration register may be the MXCSR and another representative register may be the FCW, although embodiments may be used in connection with many other configuration and status registers. Accordingly, if a μop is to write to the MXCSR, writer ID generator 25 may assign an identifier to such μop, e.g., in a round robin fashion. More specifically, writer ID generator 25 may assign different IDs of dedicated ID sets for each of different writer instruction types. For example, an ID of a first set may be assigned for a MXCSR write μop, and an ID of a second set may be assigned for a FCW write μop. As will be described further below, these identifiers may be used to track both dependent sops that depend on such write instructions (also referred to as “reader μops”), as well as to track processing and retirement of μops after execution.

Referring still to FIG. 1, μops pass from allocator 20 to a reservation station 30 when needed resources are indicated to be available. Reservation station 30 may be used to track dependencies between instructions and to issue the instructions (and associated source operands) to one or more execution units 40 for execution. As shown in FIG. 1, reservation station 30 includes a content addressable memory (CAM) 35. CAM 35 may include a plurality of entries to track dependency between a writer μop and depending reader μops that read a state of the written-to control register during their execution. To track these dependencies, allocator 20 may associate the writer IDs to dependent reader μops so that these dependent reader μops can be stored in CAM 35 with their dependency indicated. In some embodiments, separate CAMs may be present for tracking dependency of instructions for different types of writer instructions. That is, a first CAM set may be used to track dependency for FCW writer instructions, while a second CAM set may be used to track dependency of writer instructions for the MXCSR. In one embodiment, CAM 35 may be addressable via a 4-bit identifier so that the dependency for 16 such writer instructions may be handled.

As described above, reservation station 30 controls passing of μops to execution units 40 for execution of various operations. While the scope of the present invention is not limited in this regard, the execution units may include a floating point unit (FPU), an integer unit (IU), and address generation unit (AGU), among others. As further shown in FIG. 1, various storage structures may be coupled to execution units 40, including, for example, control and status registers 60 and a memory interface unit (MIU) 70, which may include a register file 75. Control and status registers 60 may include state information for processor 10, as well as various configuration information regarding default modes for performing certain operations. Furthermore, these registers may also include status information that is updated upon retirement of a given instruction to indicate if the instruction resulted in an enumerated type of exception so that desired exception handling may be performed, based on whether the exception(s) are masked or unmasked. As described above, there may be considerable overhead associated with updating the state in control and status registers 60. Accordingly, in various embodiments MIU 70 may include register file 75 having individual registers to store entries having re-named or replicated versions of at least portions of certain control registers. Continuing with use of the MXCSR as an example, each register or entry 76₀-76n (generically entry 76) of register file 75 may include at least a portion of information present in the MXCSR, as well as at least a portion of the information present in the FCW. Of course in other implementations additional, different or lesser amounts of information may be stored in entries 76. Further, information from other control registers also may be stored.

In some embodiments, register file 75 may include a plurality of 16-bit registers, while in other embodiments such registers may be 32 bits, although the scope of the present invention is not limited in this regard. In one embodiment, each entry 76 may include two dedicated portions, one portion for storage of replicated MXCSR information and one portion for storage of replicated FCW information. However, in other implementations separate registers of register file 75 for replicated MXCSR information and replicated FCW information may exist.

Referring now to Table 1, below, shown is a programmer's view of the MXCSR and FCW registers.

TABLE 1

| | | | | | | | | | | | | | | | |
|---|---|---|---|---|---|---|---|---|---|---|---|---|---|---|---|
| 15 | 14 | 13 | 12 | 11 | 10 | 9 | 8 | 7 | 6 | 5 | 4 | 3 | 2 | 1 | 0 |

MXCSR

| | | | | | | | | | | | | | | |
|---|---|---|---|---|---|---|---|---|---|---|---|---|---|---|
| FTZ | Rnd_Ctl | PM | UM | OM | ZM | DM | IM | DAZ | PE | UE | OE | ZE | DE | IE |

FCW

| | | | | | | | | |
|---|---|---|---|---|---|---|---|---|
| X | RC | PC | PM | UM | OM | ZM | DM | IM |

As shown in Table 1, the MXCSR register may include control information used for performing operations on, e.g., single instruction multiple data (SIMD) (i.e., bits 6-15 of the MXCSR). This information may be used to control rounding modes and other operations, as well as to identify exceptions to be masked. In addition, Table 1 shows the presence of exception flags of the MXCSR (i.e., bits 0-5). During operation of embodiments of the present invention, such exception flags may be provided in connection with retirement of instructions in a one per thread copy in a retirement register file of a reorder buffer of a retirement unit, for example, which may be written by retiring instructions in the order in which they retire. As further shown in Table 1, a programmer's view of the FCW includes control information (i.e., bits 8-11 of the FCW) which may be used to control rounding and precision. Furthermore, the FCW includes a plurality of bits to identify exceptions to mask (i.e., bits 0-5).

In various embodiments, multiple replicated entries of at least portions of the information in the MXCSR and the FCW (for example) can be stored in register file 75. The MXCSR format may be set forth in Table 2, which shows a layout of a register file entry for replicated MXCSR and FCW information in accordance with one embodiment of the present invention.

TABLE 2

| | | | | | | | | | | |
|---|---|---|---|---|---|---|---|---|---|---|
| 10 | 9 | 8 | 7 | 6 | 5 | 4 | 3 | 2 | 1 | 0 |

FCW

| | | | | | | | | |
|---|---|---|---|---|---|---|---|---|
| IC | <RC-> | <PC-> | P | U | O | D | Z | I |

MXCSR

| | | | | | | | | | |
|---|---|---|---|---|---|---|---|---|---|
| 0 | <RC-> | FTZ | DAZ | P | U | O | D | Z | I |

By aligning the contents of an entry in register file 75 in this way, reformatting of the data, e.g., via a multiplexer or other control logic before providing the information to an execution unit can be avoided. Note that in the embodiment of Table 2, the configuration information includes control data and mask information. However, the exception information of the MXCSR (as shown in Table 1) may not be present in the replicated entries of register file 75, and may instead be provided on a once at retirement basis of a given reader instruction that is dependent on the information in an entry of register file 76. While shown with this particular implementation in Tables 1 and 2, the scope of the present invention is not limited in this manner.

For example, although shown in FIG. 1 as including individual entries 76 each accessible by an entry number (which may correspond to an identifier allocated by allocator 20), it is to be understood that in some embodiments each entry 75 may be segmented into at least two dedicated segments (e.g., each of 16 bits), one associated with the FCW and another associated with the MXCSR. Furthermore, note that while the embodiment of FIG. 1 shows a single CAM 35, in some implementations multiple CAMs may be present, each associated with a given configuration register, e.g., one CAM for the MXCSR and a separate CAM for the FCW.

When a writer μop is provided for execution in execution units 40, an entry 76 may be written in register file 75 to store the desired state information of the μop. Then, when dependent μops to this writer μop are provided to execution units 40, the operations of these sops may be performed using the state information present in the corresponding entry 76. In this way, updating of state information in control and status registers 60 may be avoided and these dependent μops may be dispatched to execution units 40 without first retiring the writer μop and committing information to the architectural state of processor 10 (i.e., writing state information of the writer μop to control and status registers 60).

As further shown in FIG. 1, after execution μops may be provided to a retirement unit 50, which reorders μops back into program order so that the correct program operation occurs. When a given writer μop and its dependent μops have retired, a signal may be fed back from retirement unit 50 to allocator 20 to indicate writer retirement so that allocator 20, and more specifically writer ID generator 25, may recycle the ID associated with the writer μop for later incoming writer μops. For example, on retirement of a writer μop (μop B), the ID assigned to the previous writer μop (μop A) that may have retired a long time ago may be freed. Retirement of μop B guarantees that all μops dependent on μop A have retired since they were between μops A and B. In one embodiment, the feedback path from retirement unit 50 to allocator 20 may be a 1-bit bus that reports on a number of writer μops retired, e.g., on a per cycle basis. Although shown with this particular implementation in the embodiment of FIG. 1, the scope of the present invention is not limited in this regard.

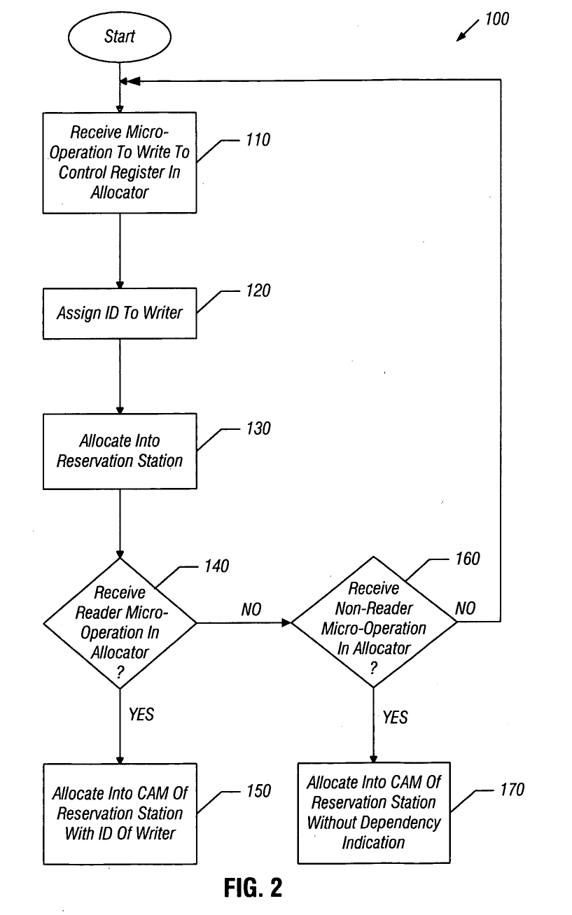

Referring now to FIG. 2, shown is a flow diagram of a method of allocating instructions in accordance with an embodiment of the present invention. As shown in FIG. 2, method 100 may begin by receiving a μop in an allocator (block 110). More specifically, the μop may correspond to an instruction that writes information into a control register, e.g., the MXCSR. Such write μops may be assigned an identifier (block 120). This identifier may correspond to an identification of the writer μop such that later dependent μops also may be associated with this identifier to allow the dependent μops to refer to a corresponding register file entry for obtaining the configuration information of the writer μop. In various embodiments, separate identifiers may be present for different control registers. For example, a first identifier of a first identifier set may be used to identify a first write μop for the MXCSR, while a first identifier of a second identifier set may be used to identify a first write μop for the FCW and so forth, although the scope of the present invention is not limited in this manner.

When needed resources for the write μop are available, the μop may be allocated into a reservation station (block 130). The reservation station may track dependency of operations and allocate μops for passing into an execution unit according to various schemes.

Referring still to FIG. 2, it may then be determined whether a reader μop has been received in the allocator (diamond 140). Such a reader μop may be a μop dependent on the writer μop. That is, the reader μop may be a micro-operation to perform a selected SIMD operation, for example, based on control information in the MXCSR to be written by the writer μop. If a reader μop is received in the allocator, the allocator may then allocate the reader μop into a CAM of the reservation station with the identifier of the writer (block 150). For example, assume that the writer μop was given an ID of 1. In this case, the reader μop may be allocated into a CAM entry of the reservation station with that same ID of 1. Furthermore, a valid indicator such as a valid bit of the CAM entry may be set as valid to indicate the dependency of this μop.

Referring still to FIG. 2, if instead at diamond 140 is determined that a μop received is not a reader, control may pass to diamond 160 to determine whether the μop is a non-reader. A non-reader may be a μop that does not need to access information written by the writer μop for performing its operation. If such a non-reader is received, control may pass to block 170 where the μop may be allocated into a CAM of the reservation station. However, this entry may be allocated without the identifier of the writer μop. For example, the entry may be allocated using a different identifier. Furthermore, the valid indicator may be reset (i.e., invalid) to indicate that no dependency exists. Note that if an incoming μop is neither a reader nor a non-reader (i.e., a writer μop), control may pass back to block 110, discussed above. While described in this particular implementation in the embodiment of FIG. 2 the scope of the present invention is not limited in this regard. Thus using method 100 of FIG. 2, incoming sops may be allocated into the reservation station and dependencies may be tracked.

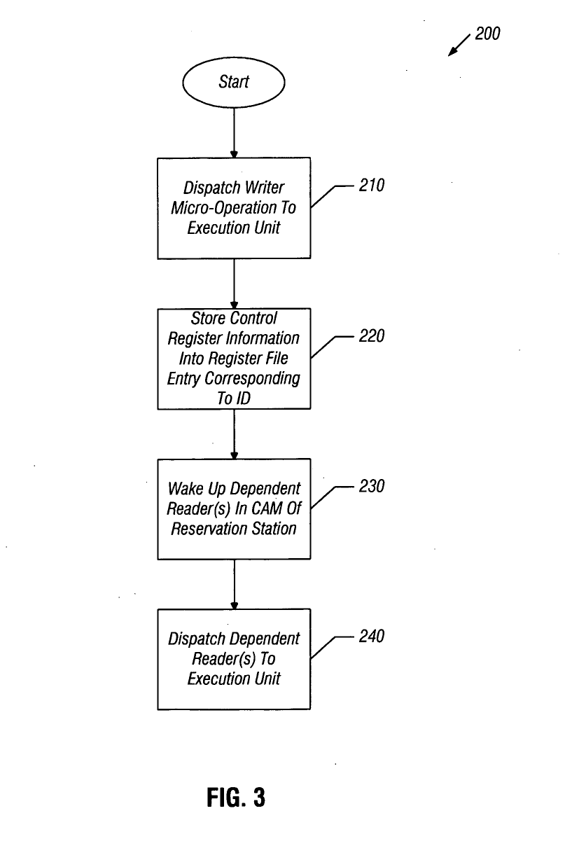

To enable execution of μops that are present in the reservation station, a dispatch process is performed. Referring now to FIG. 3, shown is a flow diagram of a dispatch method in accordance with one embodiment of the present invention. As shown in FIG. 3, method 200 may begin by dispatching a writer μop to an execution unit (block 210). For example, the reservation station, when it determines that a pending writer μop is the next μop to be sent to an execution unit, may pass the writer sop, e.g., to a floating point unit of the processor.

Referring still to FIG. 3, the writer μop may cause the execution unit to perform an instruction to write one or more new values into a control register, e.g., the MXCSR. However, to reduce the overhead associated with such an operation, embodiments of the present invention my instead store such information in a different storage location, e.g., a register file or other temporary storage location. In some embodiments, the reservation station may include logic or other control functionality to instruct the execution unit to provide its results to this storage location. Accordingly, method 200 may pass to block 220, where the control register information may be stored into a register file entry corresponding to the ID of the writer sop. Continuing with the example above, assuming that the writer μop has an ID of 1, a first entry of the register file may be written with the control information. While this register file may be a set of general-purpose registers, a dedicated storage or another location, in some embodiments the register file may be part of a memory interface unit (MIU) that may be closely associated with, e.g., a floating point execution unit. Thus, this writer μop may be completed upon storing of the updated information, although it has yet to be retired.

To take advantage of the reduced time between dispatch of the writer μop and its dependent μops, embodiments may wake up dependent readers present in CAM entries of the reservation station after the writer μop has been dispatched (block 230). Accordingly, one or more dependent μops having the same ID as the writer μop may be woken up within the CAM of the reservation station, and the reservation station may dispatch these dependent readers to the appropriate execution unit (block 240). In other words, the writer μop that writes, e.g., control information to a renamed control register may be used to schedule dependent μops. That is, because these dependent μops may be of the same ID as the writer Lop, the dispatching of these dependent reader μops will not occur until the writer μop has been executed by writing the requested control information to the indicated register of the register file. Such dispatching of dependent readers may occur after execution of the writer μop but prior to, and in some implementations, well prior to retirement of the writer μop. For example, one dependent μop may be a floating point add operation that is to operate in accordance with both a precision control and rounding control that is set forth in the writer μop. To effect this operation, a FPU adder may perform this floating point add based on the control information accessed from the register file entry of the writer μop, rather than default values present in the MXCSR. Note that while shown with this implementation in the embodiment of FIG. 3, the scope of the present invention is not limited in this regard. For example, while described as dispatching dependent μops after a writer μop is dispatched, such operations may instead be dispatched after execution of the writer μop or at another time.

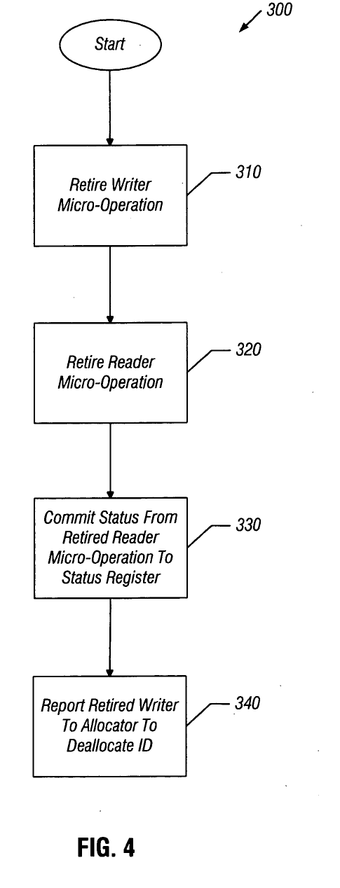

After instructions are executed in an execution unit, they may be passed to a retirement unit which takes the instructions that may be executed out of program order and reorders them back into program order. Referring now to FIG. 4, shown is a flow diagram of a retirement method in accordance with an embodiment of the present invention. As shown in FIG. 4, method 300 may be used to retire μops, and more particularly a writer μop and its dependent μops. Method 300 may begin by retiring a writer μop (block 310). Continuing with the example from above, a retirement unit may receive the writer μop, and in program order commit the operation to the architectural state of the processor. That is, the retirement unit may take the information that was written into the register file entry and commit it to the architectural state of the processor, i.e., write the control information to the MXCSR. Next, one or more reader μops dependent on this write operation may also be retired (block 320). For example, a reader operation, e.g., a floating point SIMD operation, may have its results written back to a destination operand set forth in the instruction. Furthermore, status regarding the retired reader μop may be committed to the architectural state (block 330). For example, if any exceptions were raised during the operation, such as a precision exception, a numerical exception or other such exception, a corresponding status flag may be set in the MXCSR. Note that if such an exception occurs, an exception handling routine may be performed, depending on the state of various masks for the status bits.

Finally, when the dependent μops have retired, the retirement unit may report the retired writer μop back to the allocator (block 340). In this way, the allocator may de-allocate the ID associated with the writer μop, making it available to a new incoming μop. In some implementations, such reporting of retirement of a first writer μop may not occur until retirement of a next writer μop, thus guaranteeing that all μops dependent on the first writer μop have also retired. While shown with this particular implementation the embodiment of FIG. 4, this scope of the present invention is not limited in this regard.

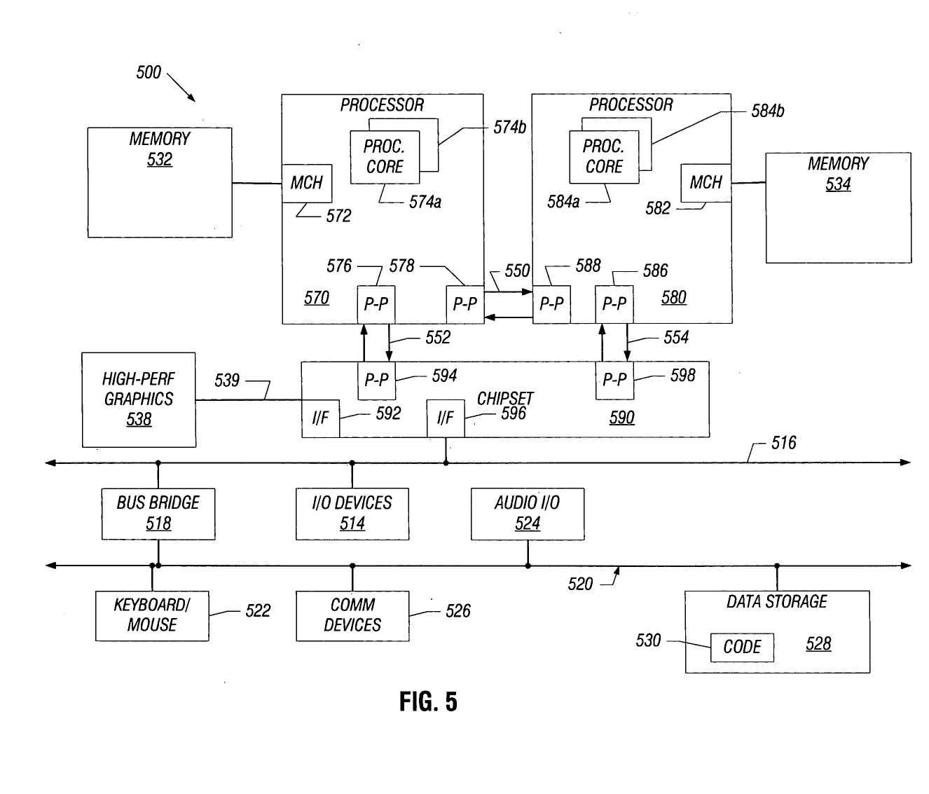

Embodiments may be implemented in many different system types. Referring now to FIG. 5, shown is a block diagram of a system in accordance with an embodiment of the present invention. As shown in FIG. 5, multiprocessor system 500 is a point-to-point interconnect system, and includes a first processor 570 and a second processor 580 coupled via a point-to-point interconnect 550. As shown in FIG. 5, each of processors 570 and 580 may be multicore processors, including first and second processor cores (i.e., processor cores 574a and 574b and processor cores 584a and 584b). Note that each of the cores may include a register file to store multiple copies of at least portions of certain control and status registers, along with control logic to track writer μops and dependent μops in accordance with an embodiment of the present invention.

First processor 570 further includes point-to-point (P-P) interfaces 576 and 578. Similarly, second processor 580 includes P-P interfaces 586 and 588. As shown in FIG. 5, memory controller hubs (MCH's) 572 and 582 couple the processors to respective memories, namely a memory 532 and a memory 534, which may be portions of main memory locally attached to the respective processors.

First processor 570 and second processor 580 may be coupled to a chipset 590 via P-P interconnects 552 and 554, respectively. As shown in FIG. 5, chipset 590 includes P-P interfaces 594 and 598. Furthermore, chipset 590 includes an interface 592 to couple chipset 590 with a high performance graphics engine 538. In one embodiment, an Advanced Graphics Port (AGP) bus 539 may be used to couple graphics engine 538 to chipset 590. AGP bus 539 may conform to the Accelerated Graphics Port Interface Specification, Revision 2.0, published May 4, 1998, by Intel Corporation, Santa Clara, Calif. Alternately, a point-to-point interconnect 539 may couple these components.

In turn, chipset 590 may be coupled to a first bus 516 via an interface 596. In one embodiment, first bus 516 may be a Peripheral Component Interconnect (PCI) bus, as defined by the PCI Local Bus Specification, Production Version, Revision 2.1, dated June 1995 or a bus such as a PCI Express™ bus or another third generation input/output (I/O) interconnect bus, although the scope of the present invention is not so limited.

As shown in FIG. 5, various I/O devices 514 may be coupled to first bus 516, along with a bus bridge 518 which couples first bus 516 to a second bus 520. In one embodiment, second bus 520 may be a low pin count (LPC) bus. Various devices may be coupled to second bus 520 including, for example, a keyboard/mouse 522, communication devices 526 and a data storage unit 528 such as a disk drive or other mass storage device which may include code 530, in one embodiment. Further, an audio I/O 524 may be coupled to second bus 520. Note that other architectures are possible. For example, instead of the point-to-point architecture of FIG. 5, a system may implement a multi-drop bus or another such architecture.

Embodiments may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
assigning a first identifier to a first instruction, wherein the first instruction is to write control information into a configuration register; and
assigning the first identifier to at least one second instruction, wherein the at least one second instruction is to read the control information to be written by the first instruction, and storing the at least one second instruction in a content addressable memory (CAM) of a reservation station with the first identifier.

2. The method of claim 1, further comprising storing a third instruction in the CAM of the reservation station with a different identifier than the first identifier, wherein the third instruction is not dependent on the first instruction.

3. The method of claim 1, further comprising:
issuing the first instruction to an execution unit and writing the control information to a location in a register file based on the first identifier; and
holding issuance of the at least one second instruction to the execution unit after the first instruction is issued to the execution unit.

4. The method of claim 3, further comprising executing the at least one second instruction according to the control information accessed from the location in the register file.

5. The method of claim 4, further comprising issuing the at least one second instruction before the first instruction retires.

6. The method of claim 4, further comprising retiring the first instruction and committing the control information from the location in the register file to the configuration register.

7. The method of claim 6, further comprising retiring the at least one second instruction and writing an exception flag to the configuration register to indicate an exception raised during execution of the at least one second instruction, wherein the configuration register comprises a control and status register.

8. An apparatus comprising:
an allocator to allocate a first identifier to a writer instruction that is to write control information to a control register; and
an instruction issuer coupled to the allocator to issue instructions to at least one execution unit, the instruction issuer including a memory to store pending instructions, wherein the instruction issuer is to hold issuance of a first pending instruction dependent on the writer instruction, until after the at least one execution unit writes the control information into an entry of a register file associated with the first identifier.

9. The apparatus of claim 8, wherein the first pending instruction is to be stored in the memory with the first identifier.

10. The apparatus of claim 8, wherein the instruction issuer is to issue the first pending instruction from the memory to the at least one execution unit before the writer instruction retires.

11. The apparatus of claim 10, wherein the instruction issuer is to store a second pending instruction in the memory with a second identifier if the second pending instruction is not dependent on the writer instruction.

12. The apparatus of claim 8, wherein the register file includes a plurality of entries each to store control information of a given writer instruction after execution by the at least one execution unit.

13. The apparatus of claim 8, further comprising a retirement unit to retire the writer instruction, wherein the retirement unit is to write the control information from the entry of the register file to the control register.

14. The apparatus of claim 13, wherein the retirement unit is to send a signal to the allocator to de-allocate the first identifier after retirement of the writer instruction.

15. The apparatus of claim 8, wherein the at least one execution unit is to access the entry of the register file to obtain the control information for use in execution of the first pending instruction if it is dependent on the writer instruction.

16. The apparatus of claim 12, wherein the plurality of entries of the register file includes a first portion of entries each to store the control information for the control register for an associated writer instruction and a second portion of entries each to store control information for a second control register for an associated writer instruction.

17. The apparatus of claim 8, wherein the memory comprises a content addressable memory (CAM) including a plurality of entries, wherein at least two of the entries are to store pending instructions dependent on the writer instruction, wherein the at least two entries are accessible via the first identifier.

18. The apparatus of claim 8, wherein the control register comprises a control and status register, and wherein a retirement unit is to write an exception occurring during the first pending instruction into the control and status register during retirement of the first pending instruction.

19. An article comprising a machine-readable medium including instructions that when executed by a machine enable the machine to perform a method comprising:
associating a first identifier with a writer instruction that is to write control information to a control register; and
tracking dependency between the writer instruction and at least one reader instruction that is dependent on the writer instruction by associating the at least one reader instruction with the first identifier in a storage and preventing dispatch of the at least one reader instruction until after dispatch of the writer instruction, wherein the storage is accessible by the first identifier.

20. The article of claim 19, wherein the method further comprises executing the writer instruction to store the control information in a register file that does not include the control register.

21. The article of claim 20, wherein the method further comprises writing the control information from the register file to the control register at retirement of the writer instruction.

22. The article of claim 20, wherein the method further comprises:
issuing the at least one reader instruction for execution after issuance of the writer instruction and prior to retirement of the writer instruction; and
executing the at least one reader instruction using the control information in the register file.

23. A system comprising:
an issuer to issue instructions to at least one execution unit, wherein the issuer is to store one or more pending instructions dependent on a first writer instruction in a content addressable memory (CAM) with a first identifier corresponding to the first writer instruction;
a register file coupled to the at least one execution unit, wherein the register file includes a first register to store configuration information of a first control register and a second register to store second configuration information of a second control register; and
a dynamic random access memory (DRAM) coupled to the register file.

24. The system of claim 23, wherein the at least one execution unit is to write the configuration information to the first register of the register file responsive to the first writer instruction and the first identifier, wherein the first control register is separate from the register file.

25. The system of claim 24, further comprising an instruction retirer to write the configuration information from the first register of the register file to the first control register on retirement of the first writer instruction.

26. The system of claim 23, further comprising an allocator coupled to the issuer to allocate the first identifier to the first writer instruction and the one or more pending dependent instructions, wherein the allocator is to allocate a second identifier to a second pending instruction dependent on a second writer instruction.

27. The system of claim 26, wherein the at least one execution unit is to write the second configuration information to the second register of the register file responsive to the second writer instruction and the second identifier.

28. The system of claim 27, further comprising an instruction retirer to write the second configuration information from the second register of the register file to the second control register on retirement of the second writer instruction.

29. The system of claim 23, wherein the issuer is to hold dispatch of the one or more pending instructions until after dispatch of the first writer instruction.
